(19) United States
(12) Patent Application Publication
(10) Pub. No.: US 2007/0227839 A1
(43) Pub. Date: Oct. 4, 2007

(54) Pad clip of disc brake

(75) Inventors: Sean Barrett, Tokyo (JP); Seiji Nishimura, Tokyo (JP); Fumiko Matsuyama, Tokyo (JP)

Correspondence Address: DRINKER BIDDLE & REATH (DC), 1500 K STREET, N.W., SUITE 1100, WASHINGTON, DC, 20005-1209, US

(73) Assignee: Akebono Brake Industry Co., Ltd.

(21) Appl. No.: 11/727,462

(22) Filed: Mar. 27, 2007

(30) Foreign Application Priority Data
Mar. 29, 2006 (JP) P.2006-091601

(51) Int. Cl. F16D 55/00

(52) U.S. Cl. 188/73.31

(57) ABSTRACT

A pad clip is provided with a pair of restraining pieces formed by bending a metal plate and remote from each other in an axial direction of a rotor. By the two restraining pieces, portions of the support member are squeezed from both sides of the support member with regard to the axial direction of the rotor so as to be supported the pad clip. By restraining to reduce a portion of the metal plate constituting a scrap by promoting a performance of blanking from the metal plate by devising shapes of the two restraining pieces, low cost formation is achieved by increasing yield of a material.

This application claims foreign priority from Japanese Patent Application No. 2006-091601, filed on Mar. 29, 2006, the entire contents of which are hereby incorporated by reference.

### BACKGROUND OF THE INVENTION

1. Field of the Invention

The invention relates to a pad clip mounted in a disc brake for braking a vehicle. The pad clip enables a pressure plate of a brake pad made of a metal of steel or the like smoothly displace relative to a support member similarly made of a metal. The pad clip is also provided with a function for preventing the pressure plate of the brake pad from rattling relative to the support member when the vehicle is not braked.

2. Related Art

In order to brake a vehicle, a disc brake is widely used. A pad clip made by an elastic metal plate having corrosion resistance of a stainless steel plate or the like is disposed between a support member and a pressure plate of a brake pad constituting such a disc brake. Further, the pad clip is constituted to smoothly displace the pressure plate relative to the support member by preventing the pressure plate made of a metal of steel or the like and the support member similarly made of a metal from being rusted. A structure of such a pad clip has been known as described in, for example, Patent References 1 through 7.
[Patent Reference 1] JP-B-57-059450
[Patent Reference 2] JP-A-05-280563
[Patent Reference 3] JP-A-05-288230
[Patent Reference 4] JP-A-2004-218696
[Patent Reference 5] JP-T-2003-517143
[Patent Reference 6] JP-U-56-153634
[Patent Reference 7] JP-U-58-178531

FIGS. 24 through 26 show an example of a disc brake attached with a pad clip described in Patent Reference 4 among these. In order to constitute the disc brake, a support member 1 provided in a state of being contiguous to one side of a rotor (not illustrated) rotated along with a wheel is fixed to a suspension. A caliper 2 is supported by the support member 1 to be able to displace in an axial direction (obverse and reverse direction of FIG. 24) of the rotor. Further, portions of the support member 1 are provided with a pair of engaging portions 3, 3 at positions of being remote from each other in a rotating direction of the rotor on both sides with regard to the rotating direction of the rotor. According to the respective engaging portions 3, 3, front ends thereof are bent in a U-like shape to ride over an outer peripheral portion of the rotor in an obverse and reverse direction of FIG. 24, and both end portions of a pair of brake pads 4 provided in a state of interposing the rotor are supported by the two engaging portions 3, 3. The two brake pads 4 are constituted by respectively attaching linings 6 to faces of the pressure plate 5 on one sides, and by engaging engaging projected portions 7, 7 formed at both end portions of the pressure plate 5 among these with engaging grooves 8, 8 formed at the two engaging portions 3, 3, the two end portions of the pair of brake pads 4 are supported by the two engaging portions 3, 3 to be able to move in an axial direction of the rotor relative thereto. Further, in both sides of the respective engaging grooves 8, 8, outer side portions with regard to a radial direction of the rotor are partitioned by projected portions 9, 9 formed in a state of being projected to the pressure plate 5.

Further, the caliper 2 having a cylinder portion and a caliper claw 10 is arranged in a state of riding over the brake pad 4, and a piston for pressing the brake pad 4 to the rotor is included in the cylinder portion among these. Further, pad clips 11, 11 constituting an object of the invention are provided between outer peripheral edges of two end portions of the pressure plate 5 constituting the respective brake pads 4 and the support member 1. The two pad clips 11, 11 are respectively integrally fabricated by metal plates having elasticity and corrosion resistance of stainless steel plates or the like to prevent the pressure plates 5 of the respective brake pads 4 from rattling relative to the support member 1 when a vehicle is not braked and prevent sliding portions of the respective pressure plates 5 and the support member 1 from being rusted.

As shown by FIG. 26, the two pad clips 11, 11 are constituted integrally by connecting an element 12a on an outer side (in being integrated to a vehicle, an end portion side in a width direction of a vehicle body with regard to an axial direction of the rotor, this side of FIG. 24) and an element 12b on an inner side (on a center side of the vehicle body with regard therewith, a depth side of FIG. 24) by a connecting portion 13. The two elements 12a, 12b are made to be able to be squeezed between the respective engaging projected portions 7, 7 and the respective engaging portions 3, 3 in a state of being elastically deformed by bending to form the metal plate in a crank-like shape. Further, with regard to the axial direction of the rotor, two end edge portions of the elements 12a, 12b are provided with tabs 14a, 14b (omitted in FIGS. 24, 25) respectively folded to bend to the engaging portions 3, 3. The respective tabs 14a, 14b squeeze the respective projected portions 9, 9 in a state of being mounted to the support member 1 to thereby position the two pad clips 11, 11 in the axial direction of the rotor.

The above-described two pad clips 11, 11 prevent the pressure plate 5 and the support member 1 respectively made of a metal of steel or the like from being rusted. Further, in braking and in releasing braking, the two pad clips 11, 11 firmly displace the pressure plate 5 in the axial direction of the rotor relative to the support member 1. Further, when a vehicle is not braked, the two pad clips 11, 11 are elastically stretched between the respective engaging projected portions 7, 7 and the respective engaging portions 3, 3 to thereby prevent the pressure plate 5 from rattling on an inner side of the support member 1.

Further, in Patent Reference 6, as shown by FIG. 27, there is described a structure of a pad clip 15 provided between a support member 1a and a pressure plate 5a of a brake pad 4a for pressing the pressure plate 5a to an outer side in a radial direction of a rotor. With regard to an axial direction of the rotor, two end edge portions of the pad clip 15 are respectively formed with tabs 16, 16. Further, by squeezing portions of the support member 1a from both sides in the axial direction of the rotor by the respective tabs 16, 16, positioning of the pad clip 15 (prevention of detachment from the support member 1a) is achieved. Also in a case of a second example of a prior art structure described in FIG. 27, by fabricating the pad clip 15 by a metal plate having elasticity and corrosion resistance of a stainless steel plate or the like, the support member 1a and the pressure plate 5a are prevented from being rusted and the brake pad 4a is prevented from rattling when a vehicle is not braked.

The respective pad clips 11, 15 are fabricated by constituting intermediate materials by punching a long metal plate drawn from an uncoiler and bending the intermediate materials. Therefore, in order to restrain fabrication cost by increasing yield of the material, it is necessary to promote a so-to-speak blanking performance by eliminating wastefulness of the material. In sum, it is important to reduce a scrap amount abandoned after punching the intermediate material from a material (metal plate). In order to reduce the scrap, it is important that the intermediate material is constituted by a shape proximate to a rectangular shape, and a shape eliminating a portion projected from an outer peripheral edge, or capable of arranging a plurality of the intermediate materials to restrain to reduce the scrap even when the projected portion is present.

The above described the pad clips 11, 15 have the following problems. First, in the case of the structure of the first example shown in FIG. 26, the intermediate material needs to be constituted by a gate-type shape constituted by connecting portions to constitute the two elements 12a, 12b by a portion to constitute the connecting portion 13. Further, it is necessary to project to constitute the respective tabs 16a, 16b from outer peripheral edges of portions to constitute the two elements 12a, 12b. It is difficult to arrange the intermediate material in such a shape to restrain to reduce the scrap, and it is unavoidable that the yield of the material is deteriorated. Although also pad clips constituting portions in correspondence with the two elements 12a, 12b by separate types as described in, for example, Patent References 2, 3, 5 and the like, since portions projected from outer peripheral edges are present, it is difficult to sufficiently increase the yield of the material. In this way, it is difficult to achieve a reduction in cost since the portions projected from the outer peripheral edges are present similar to the case of the structure described in Patent Reference 6 shown in FIG. 27 mentioned above.

In contrast thereto, Patent Reference 7 describes a pad clip 17 as shown by FIG. 28. In the case of the pad clip 17 of a third example of the background art, positioning with regard to an axial direction of a rotor is achieved by engaging a positioning plate portion 18 formed by being folded to bend in a direction reverse to a direction of a brake pad at a center portion in a width direction and a support. An intermediate material for fabricating the pad clip 17 is not provided with a portion of being projected in the axial direction of the rotor from an outer peripheral edge thereof, and therefore, a reduction in cost is easy to be achieved by increasing the yield of the material. However, in the case of the pad clip 17 shown in FIG. 28 mentioned above, it seems that positioning of the clip 17 with regard to the axial direction of the rotor is achieved only by the positioning plate portion 18, and therefore, the pad clip 17 is easy to be moved relative to the support.

### SUMMARY OF THE INVENTION

One or more embodiments of the invention provide a pad clip for a disc brake capable of being firmly positioned relative to a support member and easy to achieve low cost formation by increasing yield of a material.

In accordance with one or more embodiments of the invention, a pad clip of a disc brake formed by bending a metal plate having an elasticity is provided with a pair of restraining pieces remote from each other in an axial direction of a rotor. The pad clip is supported by a pad supporting member in a state of squeezing a portion of the pad supporting member by the two restraining pieces from both sides of the pad supporting member with regard to the axial direction of the rotor. In the pad clip, the two restraining pieces are formed by bending to raise a pair of tabs provided at portions of the metal plate in the same direction with regard to an obverse and reverse direction of the metal plate. In the pad clip, front end sides of the pair of tabs before being bent are disposed on sides proximate to each other, and base ends of the pair of tabs before being bent are disposed on sides remote from each other.

In the pad clip, the pad supporting member may be a support member, and the support member may hold a pressure plate of a brake pad to be able to displace in the axial direction of the rotor. In addition, the pad clip may further be provided with: a torque receiving portion and an anti-rattle portion. The torque receiving portion may be constituted by a flat plate shape, and squeezed between an end face of the pressure plate and the support member with regard to a rotating direction of the rotor for supporting a brake torque applied to the brake pad in braking. The anti-rattle portion may be provided at a portion separate from the torque receiving portion and squeezed between the pressure plate and the support member in a state of being elastically deformed for preventing the brake pad from rattling relative to the support member.

Moreover, in the pad clip, front end portions of the two restraining pieces may be bent in directions of being remote from each other.

According to the pad clip constituted as described above, there can be realized the pad clip for a disc brake capable of firmly carrying out positioning relative to the support member of the support member or the like, further, easy to achieve low cost formation by increasing yield of a material.

First, portions of the support member constituting the disc brake are squeezed by the pair of restraining pieces from both sides of the support member with regard to the axial direction of the rotor, and therefore, positioning relative to the support member can firmly be carried out by preventing the pad clip for a disc brake from being shifted to move in the axial direction.

Further, according to the pair of tabs for constituting the two restraining pieces, the front end sides of the respectives are disposed on the sides proximate to each other, the base end portions of the respectives are disposed on the sides remote from each other, respectively, and the front end sides and the base end sides are not projected from an outer peripheral edge of an intermediate material constituting the metal plate (present at inner portions of the intermediate material). Therefore, low cost formation can be achieved by increasing yield of the material by restraining to reduce a portion constituting a scrap in accordance with blanking for providing the intermediate material.

Further, when front end portions of the two restraining pieces are bent in directions of being remote from each other, the interval between the front end edges of the pair of restraining pieces can be made to be larger than an interval between portions for elastically squeezing the support member at middle portions of the two restraining pieces. Therefore, an operation of elastically squeezing the support member between the middle portions of the two restraining pieces can be facilitated.

Other aspects and advantages of the invention will be apparent from the following description and the appended claims.

### BRIEF DESCRIPTION OF THE DRAWINGS

FIG. 1 is a perspective view showing a pad clip of a first exemplary embodiment of the invention.

FIG. 2 is a front view of the pad clip of the first exemplary embodiment.

FIG. 3 is a left side view of the pad clip of the first exemplary embodiment.

FIG. 4 is a right side view of the pad clip of the first exemplary embodiment.

FIG. 5 is a plane view of the pad clip of the first exemplary embodiment.

FIG. 6 is a plane view showing a state of mounting the pad clip of the first exemplary embodiment to a support member.

FIG. 7 is a front view of the state of mounting the pad clip of the first exemplary embodiment to the support member.

FIG. 8 is a view enlarging A portion of FIG. 6.

FIG. 9 is a view enlarging B portion of FIG. 7.

FIG. 10 is a view viewing an intermediate material from a direction the same as that of FIG. 3.

FIGS. 11(A) to 11(C) illustrate outline views showing three examples.

FIG. 12 is a perspective view showing a second exemplary embodiment of the invention.

FIG. 13 is a perspective view showing a third exemplary embodiment.

FIG. 14 is a perspective view showing a state of mounting the pad clip of the third exemplary embodiment to a support member.

FIG. 15 is a front view showing a fourth exemplary embodiment of the invention.

FIG. 16 is a left side view of the pad clip of the fourth exemplary embodiment.

FIG. 17 is a right side view of the pad clip of the fourth exemplary embodiment.

FIG. 18 is a plane view of the pad clip of the fourth exemplary embodiment.

FIG. 19 is a view similar to FIG. 8 showing a state of mounting the pad clip of the fourth exemplary embodiment to a support member.

FIG. 20 is a view similar to FIG. 9 of the pad clip of the fourth exemplary embodiment.

FIG. 21 is an outline view showing a state of blanking an intermediate material of the pad clip of the fourth exemplary embodiment.

FIG. 22 is a partial outline perspective view showing a pad clip of a fifth exemplary embodiment of the invention.

FIG. 23 is an outline perspective view showing a sixth exemplary embodiment of the invention.

FIG. 24 is a front view showing a disc brake integrated with a pad clip of a first example of a background art.

FIG. 25 is a view enlarging C portion of FIG. 24.

FIG. 26 is a view viewing a pad clip on a right side of FIG. 24 from a left side of the drawing.

FIG. 27 is a front view showing a disc brake integrated with a pad clip of a second example of the background art.

FIG. 28 is a perspective view of a pad clip of a third example of the background art.

### DETAILED DESCRIPTION OF EXEMPLARY EMBODIMENTS

### First Exemplary Embodiment

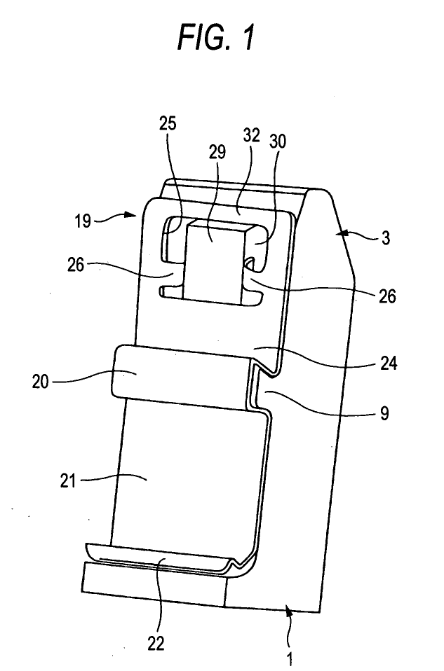

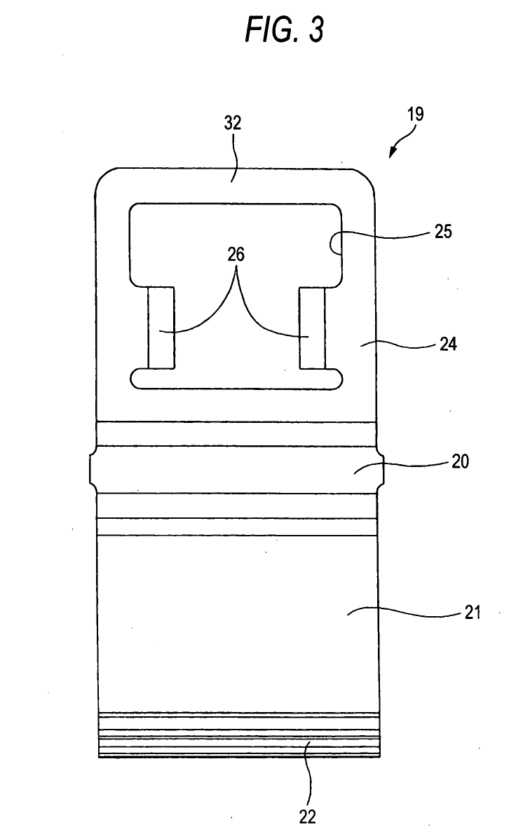

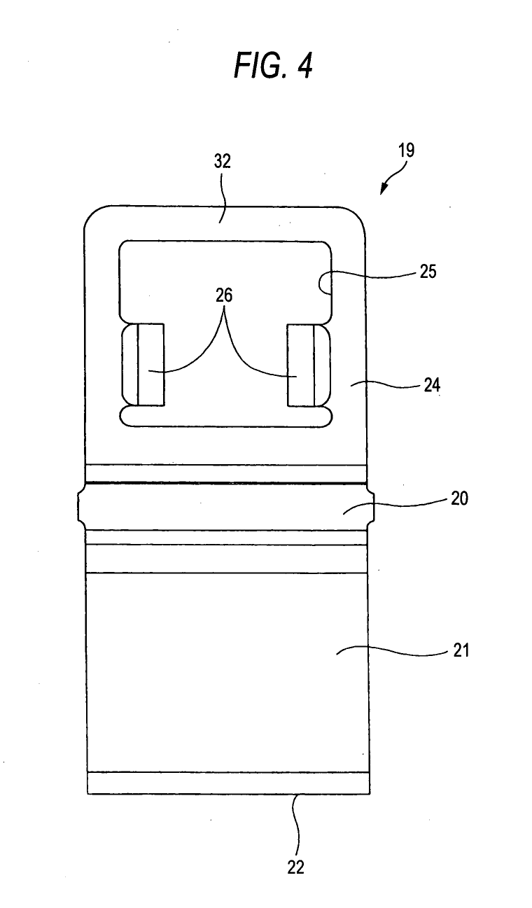

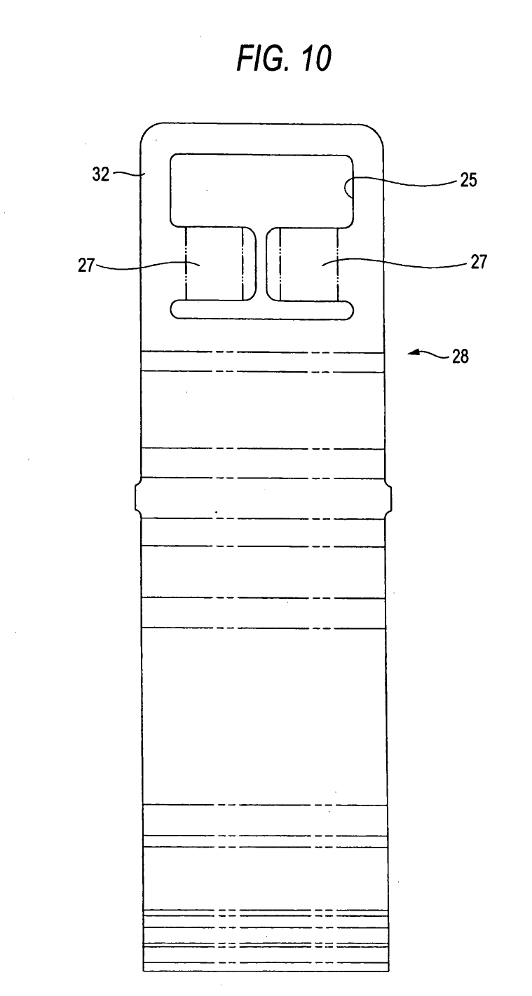

FIGS. 1 through 11 show a first exemplary embodiment of the invention. A pad clip 19 of the embodiment constituted by a shape as shown by FIGS. 1 through 9 by bending to form an intermediate material 28 as shown by FIG. 10 is fabricated by punching a thin-walled and long metal plate having corrosion resistance and elasticity of a stainless steel plate or the like drawn from an uncoiler by pressing. First, an explanation will be given of a shape of the pad clip 19 as finished.

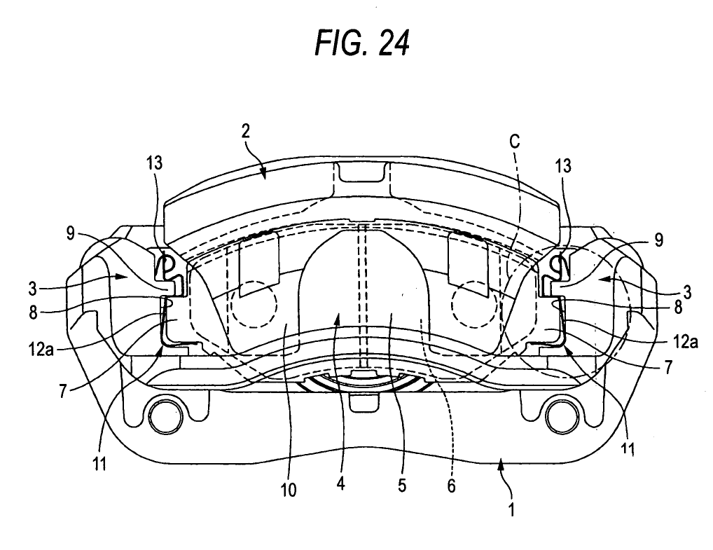

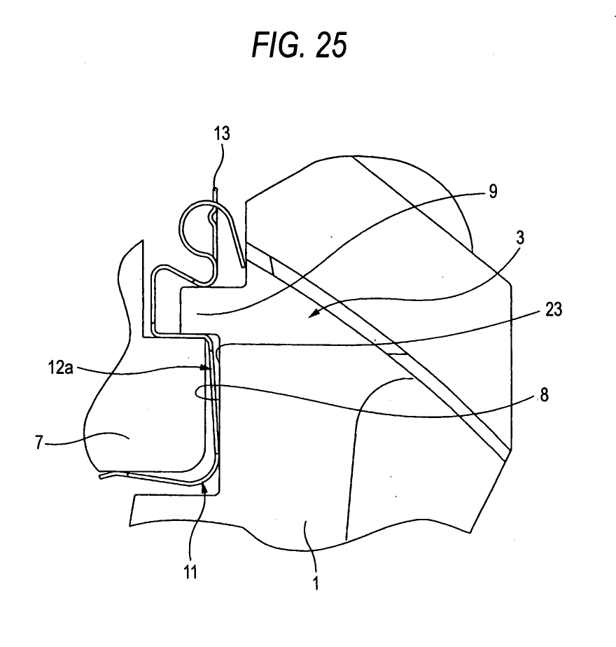

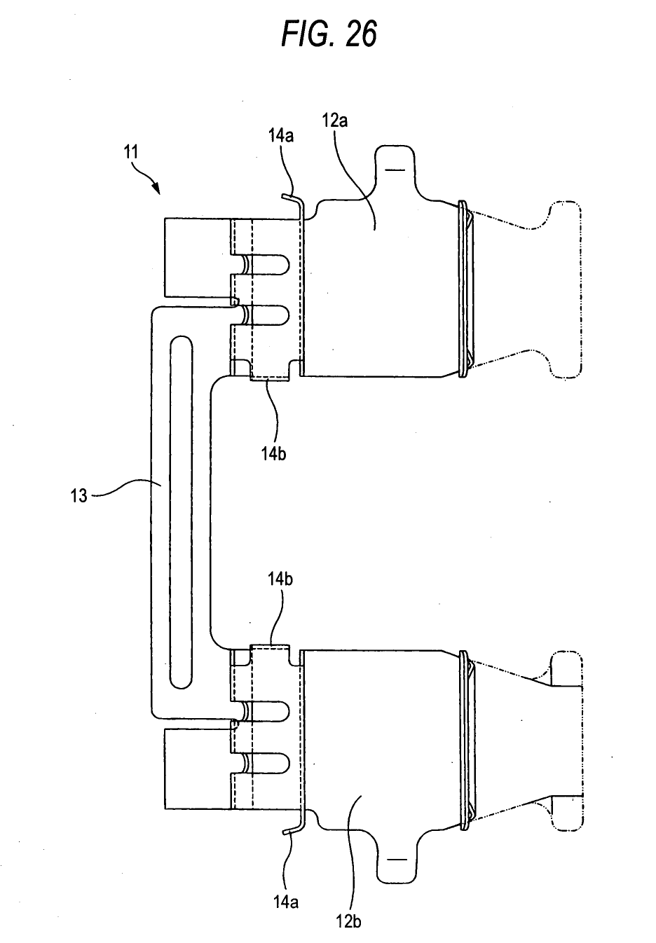

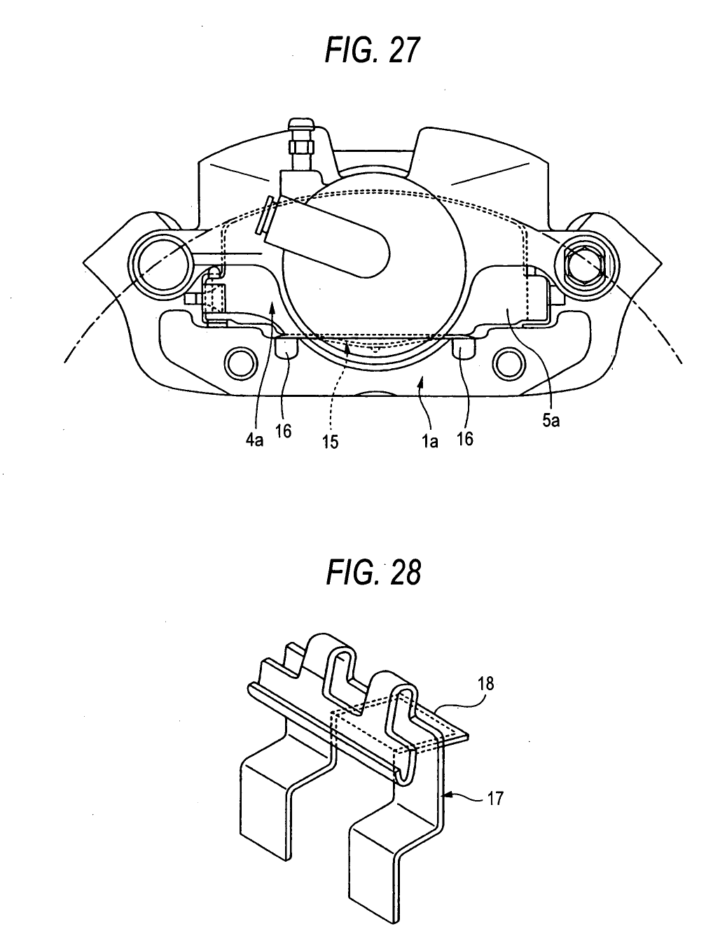

The pad clip 19 is constituted by bending to form the intermediate material 28 in a crank shape and includes a positioning portion 20, a torque receiving portion 21, and an anti-rattle portion 22. The positioning portion 20 among these is engaged with a projected portion 9 (refer to FIGS. 1, 7, 9) formed at a portion of a support member 1 (as a pad supporting member) in a state of being projected to the pressure plate 5 (refer to FIGS. 24 through 25) of the brake pad 4 to achieve positioning with regard to the radial direction of the rotor and is constituted by substantially a C-shape. Further, the positioning portion 20 is exerted with an elastic force in a direction of narrowing an opening portion in a free state. Such a positioning portion 20 elastically squeezes the projected portion 9 in a state of being mounted to the support member 1 to thereby achieve positioning of the pad clip 19 with regard to the radial direction of the rotor.

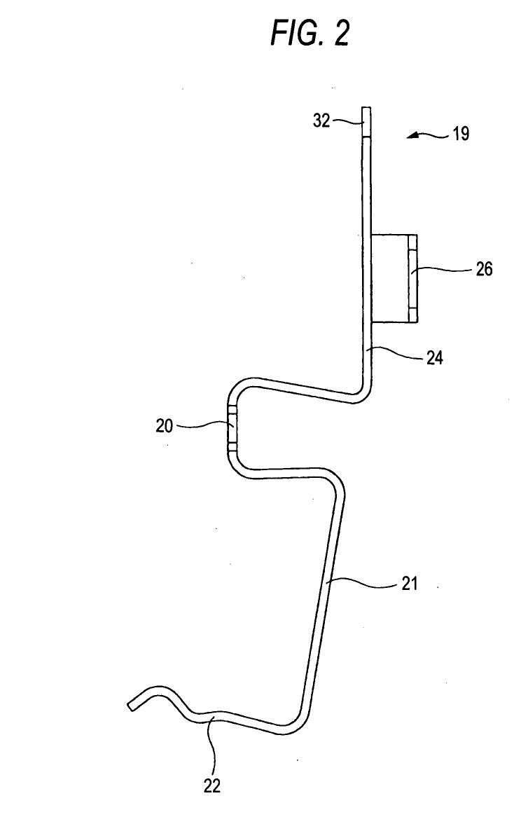

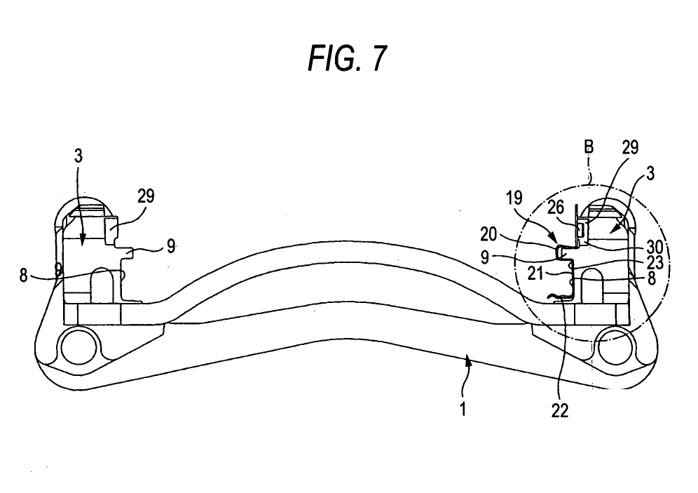

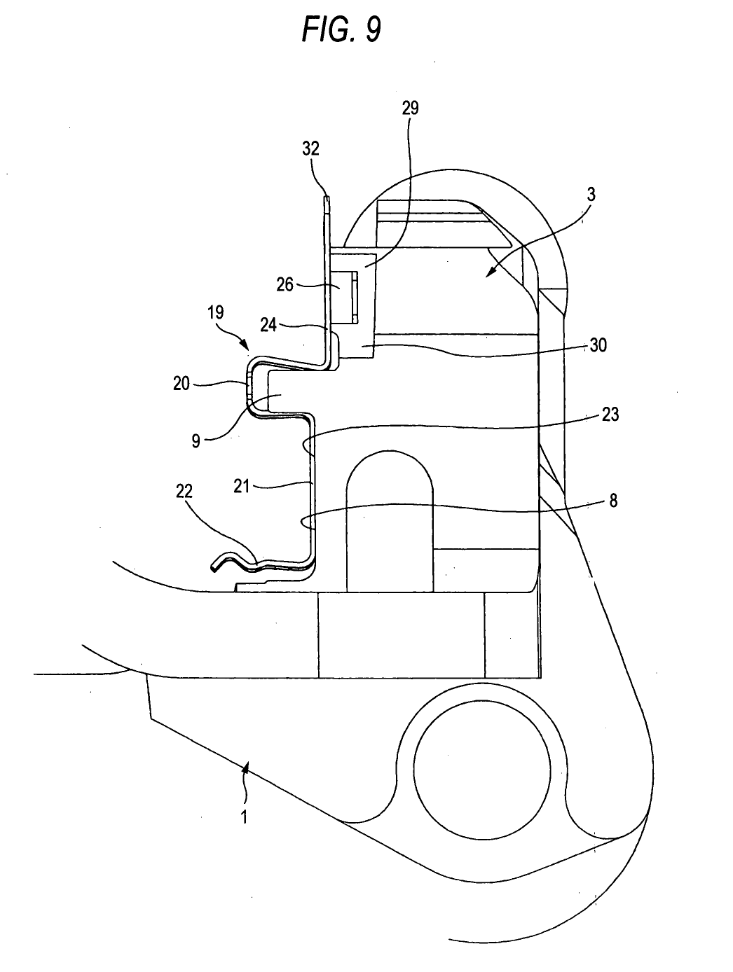

Further, the torque receiving portion 21 is provided on an inner side of the positioning portion 20 with regard to the radial direction of the rotor. That is, the torque receiving portion 21 in a flat plate shape is extended from an inner end portion of the positioning portion 20 in a radial direction of the rotor in a state of being continuous to an inner side in the radial direction. Further, in a case of a structure shown in FIG. 2, the torque receiving portion 21 and a torque receiving face 23 (refer to FIGS. 7, 9) constituting a depth face of an engaging groove 8 formed at the support member 1 are brought into contact with each other only at outer end portions in the radial direction of the rotor. In other words, at inner end portions in the radial direction, the torque receiving portion 21 is floated up from the torque receiving face 23, and the torque receiving portion 21 elastically presses the pressure plate 5 in a rotating direction of the rotor.

By the constitution, rattle of the pressure plate 5 relative to the support member 1 with regard to the rotating direction of the rotor when a vehicle is not braked is restrained, and an impact in starting to brake is alleviated. With regard to the point, the constitution is basically the same as in the case of the first example of the prior art structure shown in FIGS. 24 through 25 mentioned above (except that a position at which the torque receiving portion 21 and the pressure plate 5 are brought into contact with each other is reversed on inner and outer sides in the radial direction of the rotor), the structure is not related to the gist of the invention, and therefore, a detail explanation thereof will be omitted. Further, FIGS. 7, 9 show a structure in which the torque receiving portion 21 and the torque receiving face 23 are brought into contact with each other over an entire length of the torque receiving portion 21. It is selected which structure is adopted in view of design.

Further, the anti-rattle portion 22 is extended from the inner end portion of the torque receiving portion 21 to the center portion of the support member 1 with regard to the radial direction of the rotor. A front end portion of the anti-rattle portion 22 exerts an elastic force directed to an outer side in the radial direction of the rotor to a base end portion thereof in a free state of the pad clip 19. Therefore, in a state of mounting the pad clip 19 to the disc brake, the front end portion of the anti-rattle portion 22 is brought into contact with an inner peripheral face of the pressure plate 5 with regard to the radial direction to prevent the pressure plate 5 from rattling relative to the support member 1 when a vehicle is not braked.

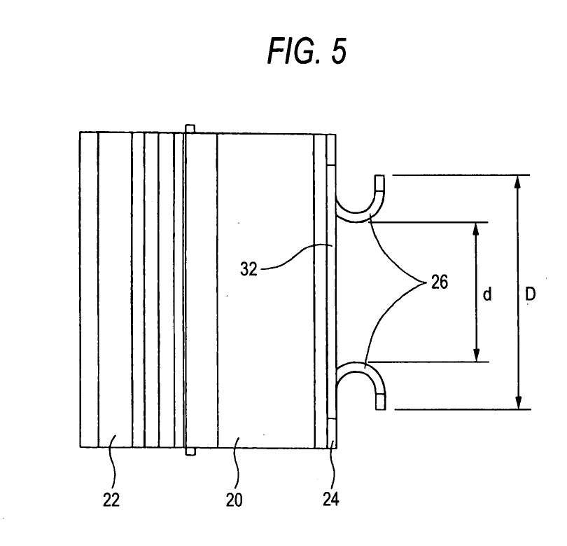

Further, a positioning plate portion 24 is provided on an outer side of the positioning portion 20 with regard to the radial direction in a state of being extended to the outer side with regard to the radial direction of the rotor. Further, a pair of restraining pieces 26, 26 are formed in an inner peripheral edge of a through hole 25 formed at the positioning plate 24 on sides opposed to each other in the axial direction of the rotor and at positions of two portions matching each other. As shown by FIG. 10, the two restraining pieces 26, 26 are constituted by constituting tabs 27, 27 projected from the inner peripheral edge of the through hole 25 to a center of the through hole 25 by constituting faces thereof opposed to each other as semicylindrical projected faces by being bent to rise in the same direction with regard to an obverse and reverse direction of the metal plate. Therefore, an interval D (FIG. 5) between the front end edges of the two restraining pieces 26, 26 is larger than an interval d between middle portions of the two restraining pieces 26, 26 (D>d).

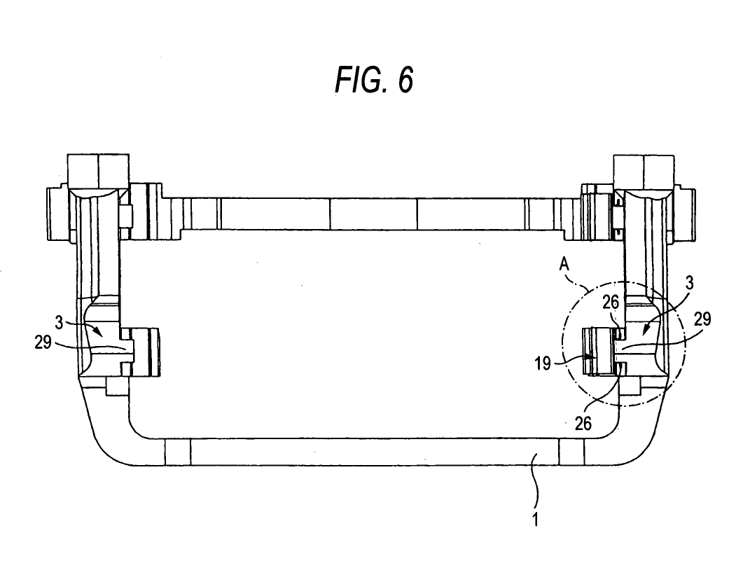

As shown by FIGS. 6 through 9, the pad clips 19 of the embodiment constituted as described above are mounted to engaging portions 3, 3 of the support member 1. That is, the positioning portions 20 constituting the pad clip 19 are outwardly fitted to the projected portions 9 provided at the respective engaging portions 3, 3 and the torque receiving portions 21 are inwardly fitted to the engaging groove 8. With regard to the point, the constitution is the same as the case of the first example of the background art structure shown in FIGS. 24 through 25 mentioned above. Further, when the pad clips 19 of the embodiment are mounted to the respective engaging portions 3, 3, by the two restraining pieces 26, 26, at portions of the respective engaging portions 3, 3, outer end portions 29 contiguous to outer sides of the projected portions 9 with regard to the radial direction of the rotor are squeezed from both sides of the support member 1 with regard to the axial direction of the rotor.

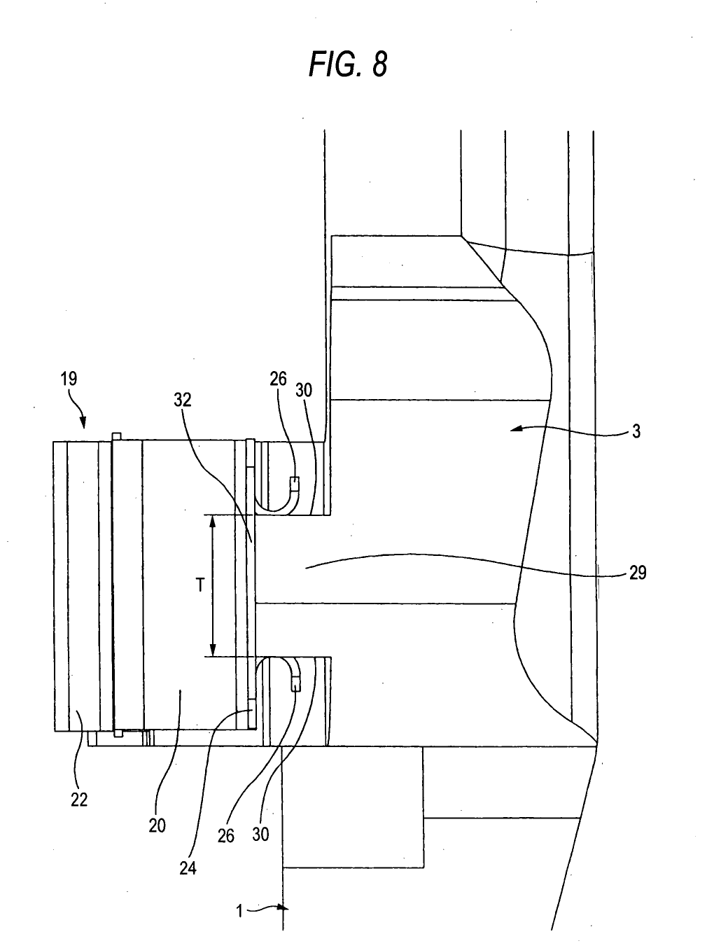

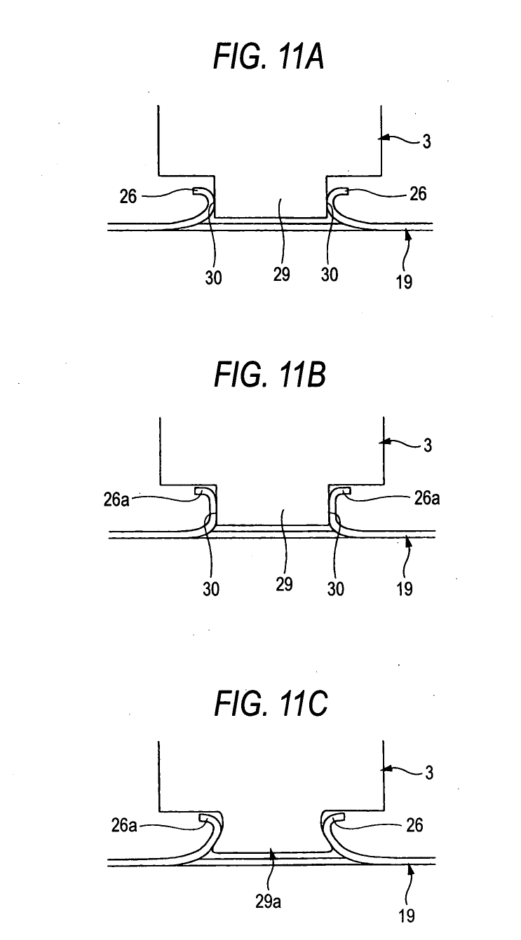

Therefore, the outer end portions 29 are formed with a pair of flat faces 30, 30 in parallel with each other to make a thickness T (FIG. 8) of the outer end portions 29 with regard to the axial direction of the rotor thinner than other portion. The thickness T is smaller than the interval D (FIG. 5) between the front end edges in the free state of the two restraining pieces 26, 26 and larger than the interval d between the middle portions of the same (D>>T>d). Therefore, when the positioning plate portion 24 is pressed to the outer end portion 29, the interval between the restraining pieces 26, 26 can be elastically expanded, and the outer end portion 29 can be squeezed by the two restraining pieces 26, 26. Therefore, an operation of mounting the pad clip 19 to the support member 1 can easily be carried out. Further, although a state of engaging the two restraining pieces 26, 26 and the outer end portion 29 mentioned above is approximately shown in FIG. 11(A), the engaging state can be constituted also as shown by FIGS. 11(B) and 11(C). In FIG. 11(B), two portions of the pair of restraining pieces 26a, 26a are made to be flat. Further, in FIG. 11(C), an outer end portion 29a is constituted by a shape of a purse in a section thereof in which a width on a depth side is narrower than a width of an end edge to thereby increase a strength of engaging the outer end portion 29a and the pair of restraining pieces 26, 26. In any of the cases, the pressure plate 5 of the brake pad 4 is engaged with the pad clip 19 mounted to the support member 1 as described above to support to be able to displace in the axial direction of the rotor relative to the support member 1.

Operation of the pad clip 19 of the embodiment constituted as described above and mounted between the support member 1 and the pressure plate 5 as described above for preventing the pressure plate 5 from rattling relative to the support member 1 when a vehicle is not braked, as well as operation of firmly displacing the brake pad 5 in braking and in releasing braking by preventing the support member 1 and the pressure plate 5 from being rusted are substantially similar to those of the case of the pad clip for a disc brake of the background art mentioned above.

Particularly, according to the pad clip 19 of the embodiment as mentioned above, positioning of the pad clip 19 relative to the support member 1 can firmly be carried out, first, low cost formation can be achieved by increasing the yield of the material.

First, the outer end portion 29 provided at the support member 1 is squeezed from the both sides of the support member 1 with regard to the axial direction of the rotor by the two restraining pieces 26, 26, and therefore, positioning relative to the support member 1 can firmly be carried out by preventing the pad clip 19 from being shifted to move in the axial direction.

Further, according to the pair of tabs 27, 27 for constituting the two restraining pieces 26, 26, as shown by FIG. 10, respective front end sides thereof are disposed on sides proximate to each other, respective base end sides are disposed on sides remote from each other, respectively, and are not projected from the outer peripheral edge of the intermediate material 28 in the flat plate shape. In other words, the two tabs 27, 27 are present at inner side portions of the intermediate material 28. Therefore, low cost formation is achieved by increasing the yield of the material by restraining to reduce a portion constituting a scrap in accordance with blanking for providing the intermediate material 28.

That is, when the pad clip 19 is fabricated, the pad clip 19 is constituted by punching a long metal plate drawn from an uncoiler by pressing to constitute the intermediate material 28 as shown by FIG. 10 and thereafter bending the intermediate material 28. As is apparent from FIG. 10 mentioned above, the intermediate material 28 is constituted substantially by the rectangular shape, and a portion projected from the outer peripheral edge (except a small projected portion produced as a result of cutting a continuous portion provided for successive feeding) is hardly present. Therefore, blanking can be carried out by making the contiguous intermediate materials 28 proximate to each other, and a portion of the long metal plate constituting the scrap can be restrained to reduce. As a result, fabrication cost of the pad clip can be restrained to reduce.

### Second Exemplary Embodiment

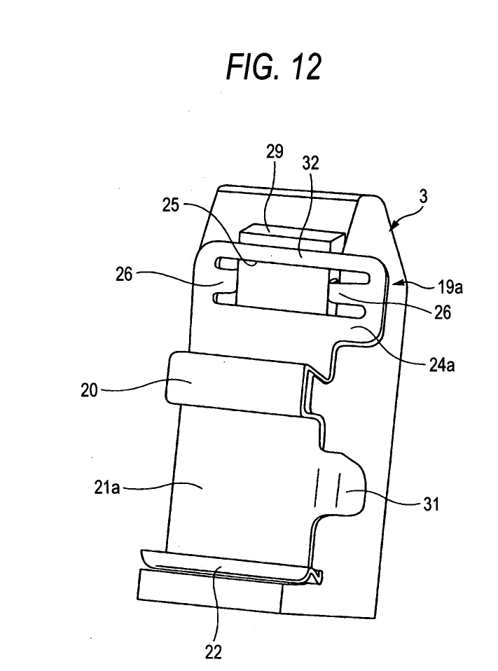

FIG. 12 shows a second exemplary embodiment of the invention. In a case of a pad clip 19a of the embodiment, a width dimension with regard to the axial direction of the rotor of a positioning plate portion 24a is made to be larger than the width dimension of the positioning portion 20 of the same. Further, in two side edges of a torque receiving portion 21a, a side edge constituting a side opposed to the rotor in a state of being integrated to the support member 1 (refer to FIGS. 6 through 9) is formed with a fold-to-bend plate portion 31 folded to bend to a side of the support member 1. The fold-to-bend plate portion 31 is brought into contact with a side face of the engaging portion 3 (refer to FIGS. 6 through 9) on a side opposed to the rotor in a state of being integrated to the support member 1. Further, the pad clip 19a is further firmly prevented from displacing to the rotor side.

Although in the case of the embodiment, a performance of blanking from a long metal plate is lower than that in the case of the first exemplary embodiment, a reduction in cost can be achieved in comparison with the background art structures described in Patent References 1 through 6 or the like. Constitution and operation of other portion are similar to those of the case of the first exemplary embodiment, and therefore, duplicated illustration and explanation will be omitted.

### Third Exemplary Embodiment

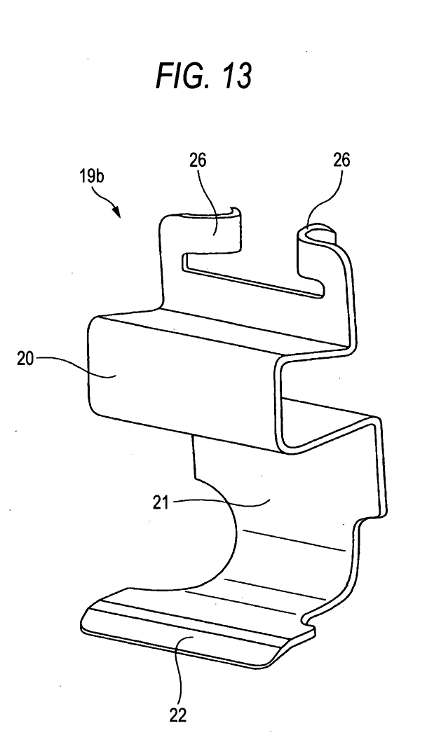

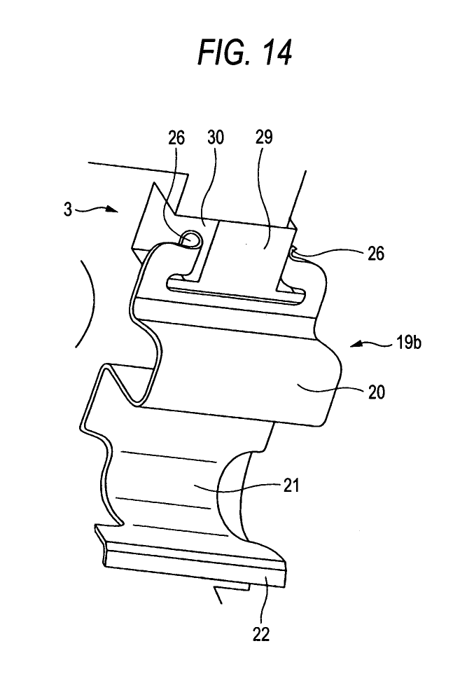

FIGS. 13 through 14 show a third exemplary embodiment of the invention. In a case of a pad clip 19b of the embodiment, a metal plate is not present at potions on outer sides of the pair of restraining pieces 26, 26 with regard to the radial direction of the rotor. Therefore, although rigidities of the two restraining pieces 26, 26 are more or less lower than those of the structure provided with a continuous potion 32 at the portion as in the above-described first exemplary embodiment and the above-described second exemplary embodiment, a reduction in cost can be achieved by reducing an amount using the metal plate by that amount.

Constitution and operation of other portion are similar to those of the case of the above-described first exemplary embodiment, and therefore, duplicated illustration and explanation will be omitted.

### Fourth Exemplary Embodiment

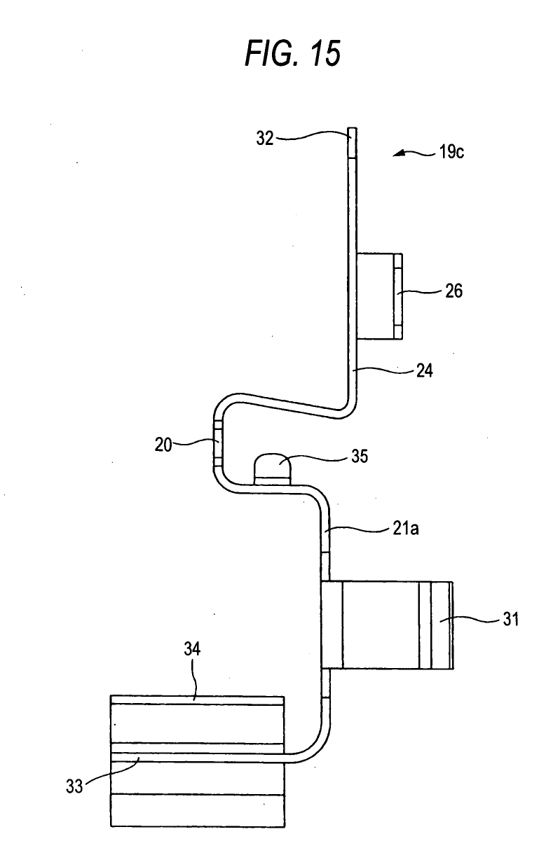

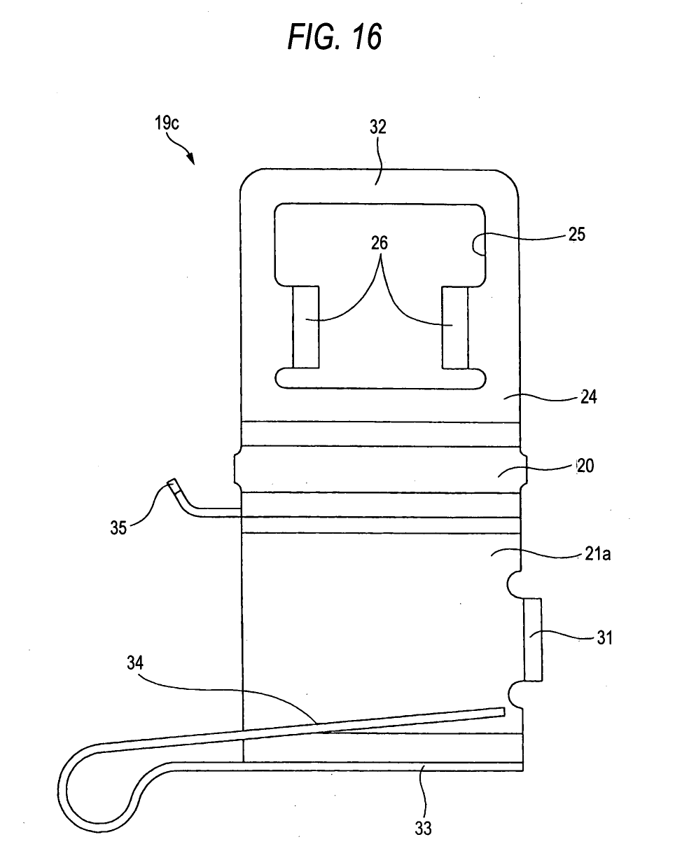

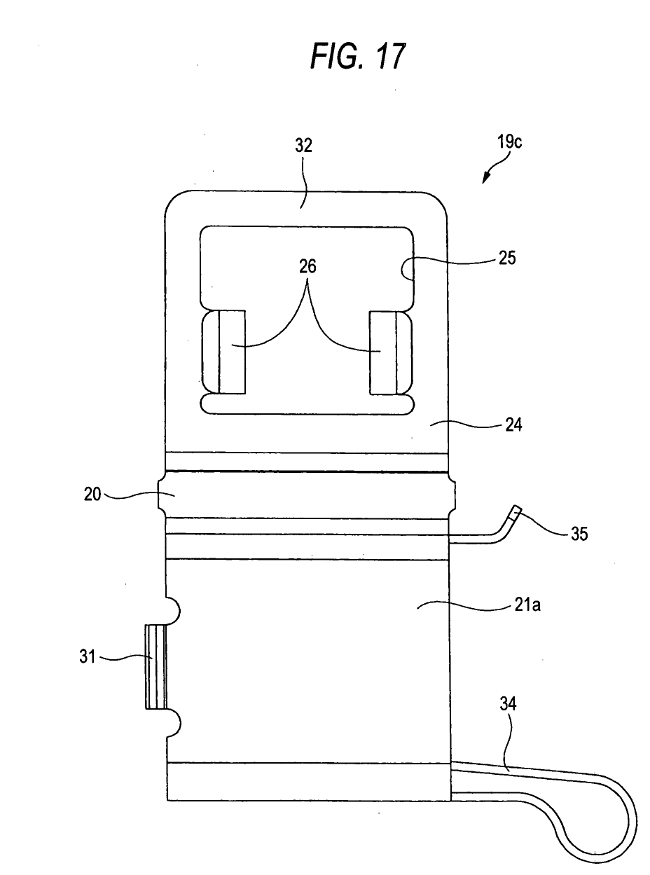

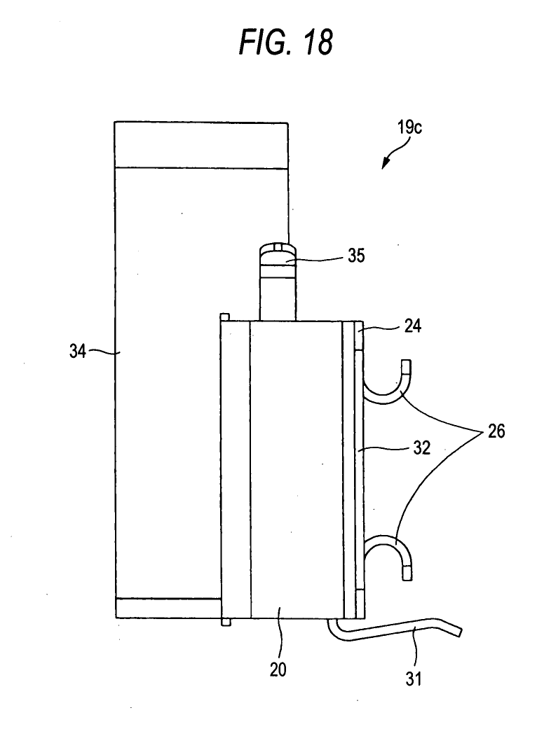

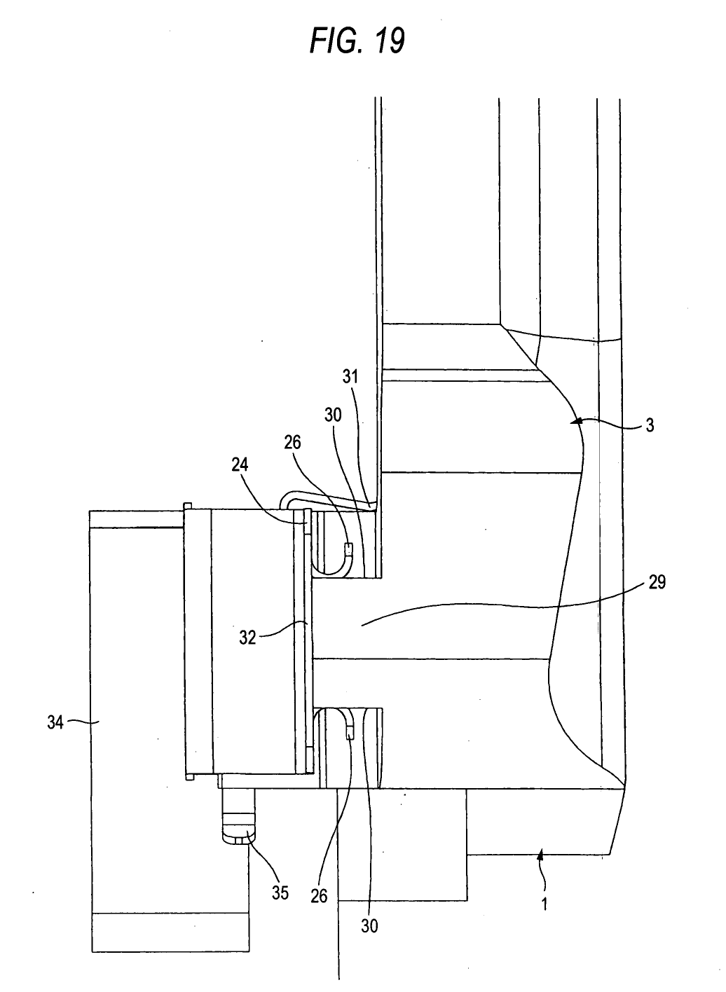

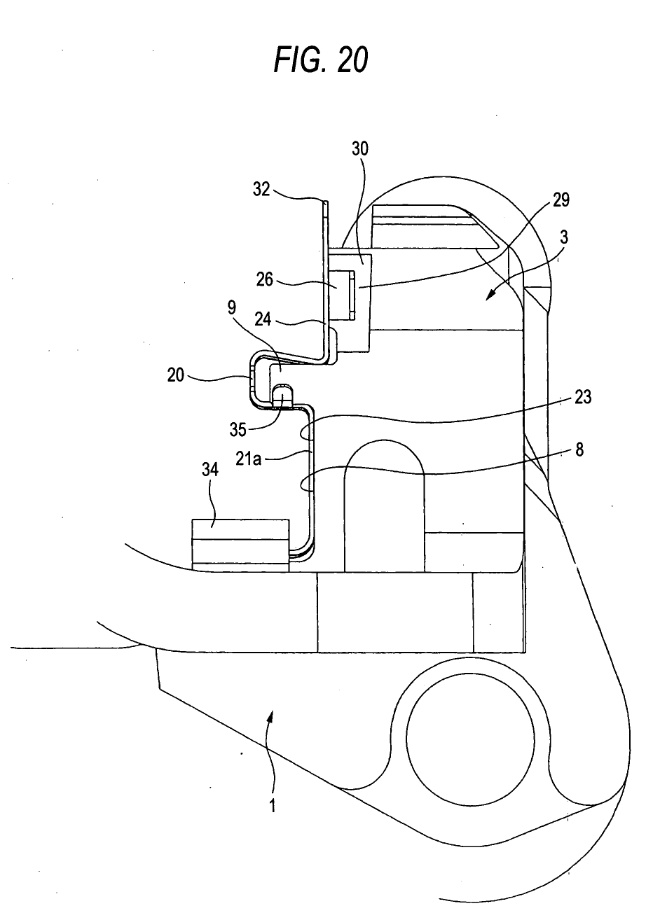

FIG. 15 through 20 show a fourth exemplary embodiment of the invention. In a case of a pad clip 19c of the embodiment, an anti-rattle portion is constituted by an elastic fold-back portion 34 in a shape of a hairpin provided in a state of being projected with regard to the axial direction of the rotor from a plate portion 33 present at an inner end portion with regard to the radial direction of the rotor. The elastic fold-back portion 34 presses the pressure plate 5 (refer to FIGS. 24 through 25) of the brake pad 4 mounted to the support member 1 to an outer side in the radial direction of the rotor in a state of being integrated to the support member 1 shown in FIGS. 19 through 20 to thereby prevent the pressure plate 5 from rattling relative to the support member 1.

In accordance with providing the elastic fold-back portion 34, in the case of the embodiment, in both side edges of the positioning portion 20, a side edge constituting a side opposed to the rotor in a state of being integrated to the support member 1 is formed with a guide projected piece 35 a front end portion of which is folded to bend to a side opposed to the elastic fold-back portion 34. When the brake pad 4 is integrated to the support member 1, the engaging projected portion 7 (refer to FIGS. 24 through 25) provided at the end portion of the pressure plate 5 is pressed to between the elastic fold-back portion 34 and the positioning portion 20 while being guided by the guide projected piece 35. Further, in the case of the pad clip 19c of the embodiment, similar to the case of the second exemplary embodiment, in two side edges of a torque receiving portion 21a, a side edge constituting the rotor side in a state of being integrated to the support member 1 is formed with the fold-to-bend plate portion 31 folded to bend to the side of the support member 1 in the state of being integrated to the support member 1.

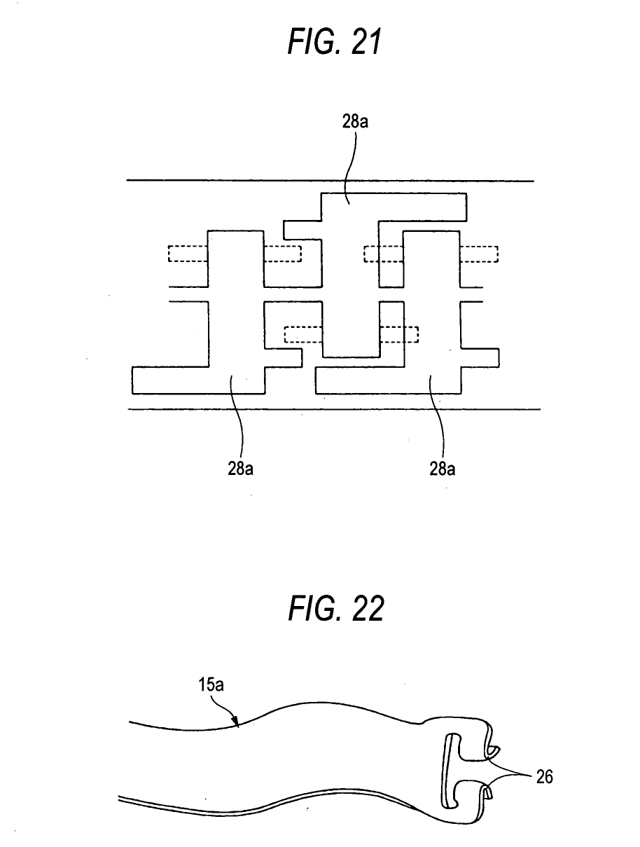

Although in the case of the embodiment provided with the elastic fold-back portion 34, the guide projected piece 35, and the fold-to-bend plate portion 31 as described above, in comparison with the case of the above-described first exemplary embodiment, the performance of blanking from a long metal plate is reduced, a reduction in cost can be achieved in comparison with the background art structures described in Patent References 1 through 6 or the like. That is, as shown by FIG. 21, when the intermediate materials 28a for fabricating the pad clip 19c are combined by devising directions between the contiguous intermediate materials 28a, 28a, in comparison with the background art structure including projected portions as shown by chain lines of the drawing, a reduction in cost can be achieved by promoting blanking performance. Constitution and operation of other portion are similar to those of the case of the first exemplary embodiment, and therefore, duplicated illustration and explanation will be omitted.

### Fifth Exemplary Embodiment

FIG. 22 shows a fifth exemplary embodiment of the invention. The embodiment shows a case of applying the invention with regard to the structure as described in Patent Reference 6. A total constitution of a pad clip 15a is as described in Patent Reference 6. Further, a point that the pad clip 15a is mounted to the support member in a state of preventing a displacement in the axial direction of the rotor by the pair of restraining pieces 26, 26 is similar to that in the case of the first exemplary embodiment except that a position of the support member to be mounted with the pad clip 15a differs, and therefore, duplicated illustration and explanation will be omitted.

### Sixth Exemplary Embodiment

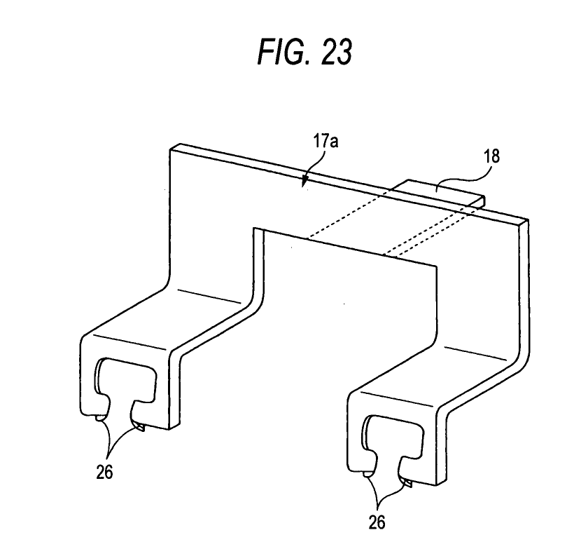

FIG. 23 shows a sixth exemplary embodiment of the invention. The embodiment shows a case of applying the invention with regard to the structure as described in Patent Reference 7. A total constitution of a pad clip 17a is similar to that described in Patent Reference 7. Further, a point that the pad clip 17a is mounted to the support member in a state of preventing a displacement in the axial direction of the rotor by the pair of restraining pieces 26, 26 is similar to that in the case of the first exemplary embodiment except a position of the support member to be mounted with the pad clip 17a differs, and therefore, duplicated illustration and explanation will be omitted.

It will be apparent to those skilled in the art that various modifications and variations can be made to the described exemplary embodiments of the invention without departing from the spirit or scope of the invention. Thus, it is intended that the invention cover all modifications and variations of this invention consistent with the scope of the appended claims and their equivalents.

What is claimed is:

1. A pad clip of a disc brake formed by bending a metal plate having an elasticity, the pad clip comprising:
a pair of restraining pieces remote from each other in an axial direction of a rotor,
wherein the pad clip is supported by a pad supporting member in a state of squeezing a portion of the pad supporting member by the two restraining pieces from both sides of the pad supporting member with regard to the axial direction of the rotor,
the two restraining pieces are formed by bending to raise a pair of tabs provided at portions of the metal plate in the same direction with regard to an obverse and reverse direction of the metal plate,
front end sides of the pair of tabs before being bent are disposed on sides proximate to each other, and
base ends of the pair of tabs before being bent are disposed on sides remote from each other.

2. The pad clip according to claim 1, wherein the pad supporting member comprises a support member,
the support member holds a pressure plate of a brake pad to be able to displace in the axial direction of the rotor, and
the pad clip further comprises:
a torque receiving portion for supporting a brake torque applied to the brake pad in braking, the torque receiving portion being squeezed between an end face of the pressure plate and the support member with regard to a rotating direction of the rotor; and
an anti-rattle portion provided at a portion separate from the torque receiving portion and squeezed between the pressure plate and the support member in a state of being elastically deformed for preventing the brake pad from rattling relative to the support member.

3. The pad clip according to claim 1, wherein front end portions of the two restraining pieces are bent in directions of being remote from each other.
